(19) United States
(12) Patent Application Publication
(10) Pub. No.: US 2019/0034679 A1
(43) Pub. Date: Jan. 31, 2019

(54) Transportable Passage Control Device for a Work Area

(71) Applicant: Robert Bosch GmbH, Stuttgart (DE)

(72) Inventors: Joachim Schadow, Stuttgart (DE); Florian Esenwein, Leinfelden-Echterdingen (DE)

(21) Appl. No.: 16/072,293

(22) PCT Filed: Nov. 24, 2016
(86) PCT No.: PCT/EP2016/078651

§ 371 Date: Jul. 24, 2018

(30) Foreign Application Priority Data
Dec. 21, 2015 (DE) 10 2015 226 354.1

(51) Int. Cl. G06K 7/10; G06K 19/06; G07C 9/00

(52) U.S. Cl. CPC G06K 7/10861; G07C 9/00158; G06K 19/06037

(57) ABSTRACT

A passage control device for an access-restricted work area includes at least one detection element and at least one data processing device. The passage control device is configured as a mobile device and checks the passage of a person to the access-restricted work area so as to assign the person a work sub-area and/or a specific activity within the access-restricted work area if the at least one data processing device has identified the person detected based on the at least one detection element and/or the equipment carried by the person as having access authorization.

### PRIOR ART

The invention relates to a passage control device for an access-restricted work area, as well as to a system consisting of a plurality of passage control devices according to the type indicated in the independent claims 1 and 11. In addition, the invention relates to a method for carrying out a passage control check with a passage control device according to the type of the independent claim 12.

As a rule, passage to access-restricted work areas, such as construction sites or the like, have little or no access controls, so that they are freely accessible to almost everyone. In the case of large construction projects, such as manufacturing plants, etc., in some cases there are gates staffed by porters where tradespeople and workers must sign in, to allow an overview to be obtained of who is on the building site at what times and in order to have some control over which items are brought onto the construction site and later removed again. However, this passage control is usually rather superficial and lacks the facility for a more rigorous identification and verification of the purpose of the person entering the work area, as well as the equipment carried by them. Added to this is the fact that on large-scale construction sites the passage control has no influence on the range of movement and/or the works to be carried out by the person entering the construction site, so that they can typically move freely and enter uncontrolled areas in which they could represent an obstruction and/or hazard, or which they fundamentally do not have the right to enter.

Stationary passage control devices in airports allow, in particular, checks to be made for metallic objects carried by passengers. The passage control itself is then carried out by additional security personnel in conjunction with elaborate x-ray devices or the like, which are also stationary.

Mobile passage control devices are also known, which can be temporarily set up in court buildings, for example for court proceedings requiring an appropriately high level of security. Here, too, the checks are carried out by additional security personnel, who grant or deny access manually.

It is also known, for example at entertainment events or on public transport, to control and regulate access by persons using turnstiles. Similar stationary turnstiles are also found in cinemas, public toilets or the like. The access here is usually controlled via a simple payment system and is therefore not person-dependent. In addition, items can be brought in and out freely.

The object of the invention is to provide a passage control device for different work areas, with which a person and/or their accompanying equipment can be monitored to allocate a specific activity and/or a defined work sub-area to the person within the access-restricted work area, depending on the outcome of the check.

### Advantages of the Invention

The object is achieved by a passage control device for an access-restricted work area, which has at least one detection element and at least one data processing device. It is provided according to the invention that the passage control device is designed as a mobile device and checks the passage of a person to the access-restricted work area in such a way as to assign the person a work sub-area and/or a specific activity within the access-restricted work area if the at least one data processing device has identified the person detected by means of the at least one detection element, and/or the equipment carried by the person, as having access authorization. In this way, advantageously, a cost-efficient and effective authorization management and tracking system can be provided, for example on any construction site, at short notice and in a flexible way, which provides information about who is working in which work sub-area of the access-restricted work area and when, which activity the person is performing and/or what items of equipment are located within the access-restricted work area or work sub-area. As a byproduct of this, the working safety within the access-restricted work area can also be raised to a maximum level.

An “access-restricted work area” is to be understood as a spatially defined area, within which a person with access authorization, in particular a worker, can go about his/her preferably professional activity. A typical example of such a work area is the construction site already mentioned. Other work areas which require an access restriction are also possible, such as areas with safety-relevant information and/or potential hazards to third parties. These areas can be protected against access by unauthorized persons by means of fences, masonry, walls, trenches or the like. A “work sub-area” in this context describes a space, a section and/or an area within the access-restricted work area, in which the person carries out or intends to carry out their activities. The term “mobile passage control device” is intended, in particular, to be understood to mean that the passage control device is not permanently fixed in place, so that it is only present at the site of the access-restricted work area for the duration of the necessary access restriction and can then be transported to another location without the need for time-consuming structural measures. The term “equipment” essentially describes those items of equipment which the person requires to carry out their activities. These include, for example in the case of a worker, all kinds of tools, in particular power tools, such as a drill, drill and/or impact hammer, jigsaw, circular saw, plane, screwdriver, milling machine, orbital sander, angle grinder, polishing machine, multi-function device or the like, but also the worker's personal safety equipment (PPE), such as protective clothing, work shoes, helmet, gloves, ear defenders, safety goggles, breathing apparatus, torch, gas sensor or the like. However, radio equipment, wrist watches, ladders, measuring instruments and consumables, accessories or hazardous materials can also be defined as equipment. The identification of an authorized person can be not limited just to their biometric data and/or the equipment they are carrying, but can also comprise, if appropriate, their level of education as well as any necessary instructions and tests. In addition, a “data processing device” defines a processing unit in the form of a processor with a memory, input and output means and possibly other electronic components for controlling and/or supplying power to the processing unit, wherein on the processing unit an operating program for the open-loop or closed-loop control of at least one data process is running. Since the term “data processing equipment” is known to the person skilled in the art, a detailed description will not be given.

In a further design of the invention, the passage control has at least one access enabling element, which enables a person to access the access-restricted work area in the event of access authorization being identified. Thus, in a convenient way, additional persons for access control, such as porters or the like, can be dispensed with. Such an access enabling element can be designed as a turnstile, a door, a barrier or an appropriate movable barrier element. In a particularly advantageous way such barrier elements allow a very compact design of the passage control device with low weight, but still effectively prevent unauthorized access to the access-restricted work area.

The at least one detection element is designed as a light barrier, camera, biometric sensor, weight sensor, metal detector, barcode scanner, QR code scanner, body scanner, IR scanner, UWB scanner or the like. Depending on the particular application and area of application, a plurality of different detection elements can also be used in the passage control device. Thus, for example, a camera can be used for face and/or iris recognition, a biometric sensor for detecting a fingerprint, and/or a weight sensor for measuring the weight of the person. Alternatively or additionally, the identification can also be performed using a body scanner on the basis of an outline analysis, or by means of a smart card scanner for scanning an appropriately coded identification card. In a first plausibility check therefore, an initial comparison of the captured data can be made against personal data stored in a memory of the data processing device. In order also to identify the equipment that is carried by the person, suitable devices are, for example, a metal detector, a UWB scanner and/or an IR scanner. By means of a barcode or QR code scanner, it is possible to detect appropriately coded items of equipment.

In a particularly advantageous way, the passage control device has at least one first communication interface for bidirectional data exchange with an external data processing device, in particular with a central computer or a cloud. In this case the at least one first communication interface can use wireless transmission standards, such as WLAN, BT, BILE, RFID, NFC, GSM, UMTS, Zigbee or the like, or it can transmit the data recorded and/or processed by the data processing device integrated in the passage control device by, e.g., wired means, such as via Ethernet or Powerline. By transmitting the data to the external data processing device, it is possible to manage the tracking and/or inventory function centrally for a plurality of access-restricted work areas, so that it is always known which person is located in which access-restricted work area or work sub-area with which equipment and which activity they are performing there. Thus, the invention also relates to a system consisting of a plurality of passage control devices. A further advantage of the central data processing is in the better use of resources for computationally complex analyses of the data that has been captured.

Alternatively or in addition to the above detection elements, the detection element can also be designed as an additional, wireless communication interface, by means of which a unidirectional reception or bi-directional transmission of data is possible from or to a communication interface on the person and/or on the equipment carried by the person, for example in the form of a transponder, smartphone, smart band, beacon, chip, a smart watch or similar device. For the wireless data transmission, the same standards as for the at least one first communication interface are suitable. In this way, a simple and rapid control is possible on the basis of identification data relating to who brings which items of equipment into the access-restricted work area and removes items from it. On the one hand, this can reduce a potential theft risk for equipment items, while on the other hand, such a communication also allows a very precise inventory management and effective tracking, i.e. tracing or recording, of the equipment carried by the person, so that it is always known whether equipment items are located inside or outside of the access-restricted work area and which equipment items are located in each work sub-area within the access-restricted work area, and/or which activities have been carried out by the person.

Preferably, the passage control device is designed as a substantially gate-like frame construction, as a lock gate or as at least one beacon, to ensure easy transportation while at the same time allowing the maximum capacity for detection/identification and security for the access-restricted work area.

In a further design, the passage control device is supplied with energy by at least one power supply unit, an energy recovery unit, an energy conversion unit and/or an energy storage unit. The power supply unit is designed, for example, as a power connector for connection to a mains supply of the access-restricted working area. Solar cells or the like are suitable for use as the energy recovery unit, while the energy storage unit can be designed as a battery, rechargeable battery, capacitor module, fuel cell or the like and an energy conversion unit can be understood to mean, e.g., a generator in the form of an internal combustion engine or the like. In particular for a mobile passage control device, in a particularly advantageous manner a self-sufficient energy supply is therefore ensured independently of the access-restricted work area.

In order to ensure that the passage control device cannot be overridden by non-authorized persons or removed from the access-restricted work area in an unauthorized manner, it has at least one connecting element for mechanically connecting it to access prevention elements enclosing the access-restricted work area and/or to anchoring or fixing elements belonging to the access-restricted work area. The term “access prevention elements” in this connection is to be understood to mean fences, masonry walls or the like. Mounting on openings, access passages or doors of the access-restricted work area is also conceivable.

In a further design, the passage control device comprises at least one output and/or display unit, in particular in the form of a human machine interface, a printer or the like, for outputting and/or displaying information about the nature and/or the scope of the access authorization. If the person has access authorization, this can be indicated to them optically, e.g. by means of a light, and/or acoustically by means of a loudspeaker. In addition, it is possible to print out a list containing the work sub-area assigned to the person, and the equipment necessary for their activity and/or the required training or knowledge. A corresponding display is also possible using a display screen mounted on the passage control device. It is also conceivable to transmit this information via the first communication interface to a smartphone, a smart watch, a smart band, a transponder provided with a display or the like, which the person carries with them.

In addition, the invention relates to a method for performing a passage control with at least one passage control device according to the invention, wherein during the passage of a person to an access-restricted work area, a verification is carried out in such a way that, in the event of access authorization being granted, a work sub-area and/or a specific activity within the access-restricted working area is assigned to the person.

In one step of the method according to the invention, the passage of the person to the access-restricted work area is identified as not having authorization if the person does not have a required instruction and/or training and/or if a piece of equipment carried by the person may not be introduced into the access-restricted work area. A person who is identified as not having authorization therefore does not obtain access to the access-restricted work area. In this case, the person is informed via a display and/or output of the reason and/or the extent of the non-authorization and/or the condition for an access authorization. In a further step of the method according to the invention, the passage to the access-restricted work area can be enabled for the person when the person has acknowledged the display and/or output.

In the event that access authorization is granted, the person is informed about the scope of the access authorization, in particular about the work sub-areas of the restricted work area to be entered and/or the activities to be performed within the work area, and/or the handling of the accompanying equipment, in particular concerning hazards associated with the equipment, and/or concerning the completeness of the accompanying equipment. In this way, it is possible simply and efficiently to trace, including for later official inspections or the like, whether the persons entering the access-restricted work area are adequately trained and informed about the activities they are to carry out.

In addition, the method according to the invention provides that information about the persons who have entered the access-restricted working area and those leaving the access-restricted working area, and/or about the equipment carried by the persons, is stored in a memory of the data processing device of the passage control device and/or an external data processing device, for inventory management and tracking.

It is further provided that, upon a threshold value for the number of violations or irregularities being exceeded by the person, a message concerning the violations or irregularities is sent to another person, in particular to the person's supervisor, and/or the access authorization of the person for the access-restricted work area is withdrawn. This allows a significant increase in security to be achieved within the access-restricted work area for the other persons present there.

The method according to the invention also provides that at least one further person located in the access-restricted work area is informed about the access by the person to the access-restricted work area, about the activities to be carried out by the person and/or about the equipment required by the person. In this way, the other person already present in the access-restricted work area can prepare for the person entering the access-restricted work area and/or the activities to be carried out together with him/her in a timely manner.

In an advantageous way, in at least one process step the at least one data processing device of the passage control device and/or the external data processing device adjust the access authorization actively in line with a modified need for the equipment carried by the person and/or for the training or level of knowledge required for the access-restricted work area or the work sub-area. This allows the flexibility of a safety concept to be further increased. Preferably, the access authorization is adjusted repeatedly, in particular on a regular basis or periodically.

Further advantages of the invention are obtained from the features specified in the dependent claims and from the drawing and the following description.

### EXEMPLARY EMBODIMENTS

### Drawings

The invention is described in the following on the basis of FIGS. 1 and 2, wherein the same reference numbers in the figures refer to the same components with an identical functionality.

Shown are:

FIG. 1: a first exemplary embodiment of a passage control device according to the invention for an access-restricted work area in a schematic view,

FIG. 2: an inner side wall of the passage control device according to the invention according to FIG. 1,

FIG. 3: a second exemplary embodiment of a passage control device according to the invention in a schematic view,

FIG. 4: a third exemplary embodiment of a passage control device according to the invention in a schematic view,

FIG. 5: a fourth exemplary embodiment of a passage control device according to the invention in a schematic view,

FIG. 6: a work sub-area of the access-restricted work area in a schematic view.

### DESCRIPTION OF THE EXEMPLARY EMBODIMENTS

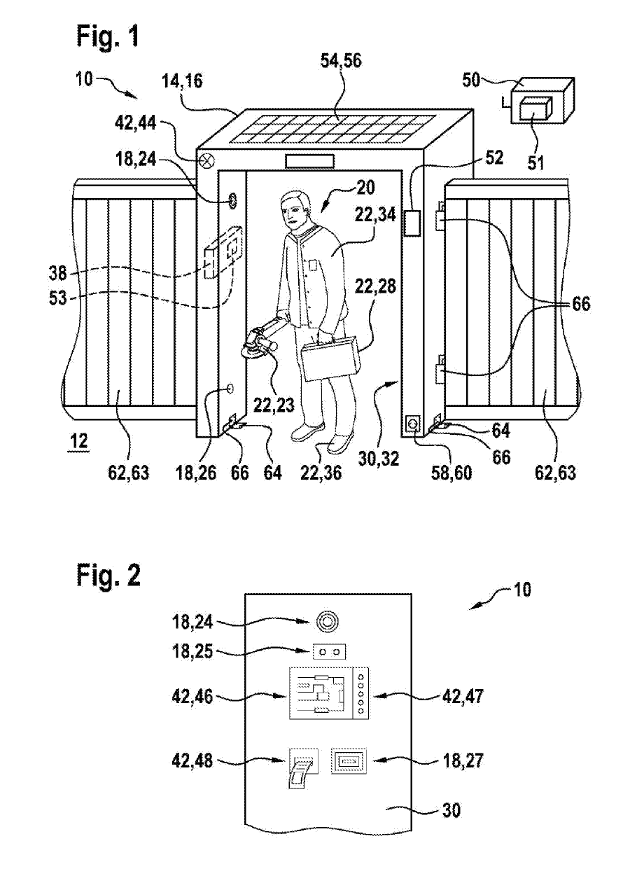

FIG. 1 shows a passage control device 10 according to the invention for an access-restricted work area 12 in a first embodiment. The passage control device 10 is designed substantially as a gate-like frame construction 14 or as a lock gate 16, and has at least one detection element 18 for detecting a person 20 and/or an item of equipment 22 carried by the person 20. In the example shown, the at least one detection element 18 is designed as a camera 24 and/or as a light barrier 26. By means of the light barrier 26 it is possible in principle to detect whether the person 20 would like to pass through the passage control device 10. It can therefore act as a trigger for the subsequent control process and activate the camera 24, by means of which a face and/or iris recognition of the person 20 can be performed. Likewise, the camera 24 can be used to capture the size and the contour of the person 20 and the equipment 22 that the person is carrying.

In the example shown, the equipment 22 consists, for example, of an angle-grinder 26 and an equipment carrying case 28. To capture the contents of the equipment carrying case 28, the passage control device has a metal detector 32 on an inner side 30 of the gate-like frame construction 14. An x-ray machine is also conceivable, however. In addition or alternatively, further detection elements 18 are also conceivable in the form of a biometric sensor 25 for fingerprint, skin, iris recognition or the like (cf. FIG. 2), a barcode or QR code scanner for detecting a symbol code printed on the equipment, an identity document scanner 27 (cf. FIG. 2) and/or an infrared (IR) or Ultra-Wide Band (UWB) scanner to distinguish between human and non-human tissue. The detection elements 18 listed here are only given as examples and are not exhaustive.

By means of the at least one detection element 18, equipment items for personal protection equipment (PPE) can also be detected. In FIG. 1, these are a protective jacket 34 and work shoes 36, for example. With regard to the introduction however, equipment can be essentially anything that is required for carrying out a proposed activity within the access-restricted work area 12. In this connection, the activity to be conducted does not necessarily need to be conducted by the person 20 themselves. The equipment 22 carried by the person 20 can also comprise objects which are needed by other people within the access-restricted work area 12 to conduct their activities.

In addition, the passage control device 10 has at least one data processing device 38 connected to the at least one detection element 18, which is designed in a standard, known manner as a processing unit in the form of a processor with a memory, input and output means and possibly other electronic components, not shown here, for controlling and/or supplying power to the processing unit for controlling and/or supplying power to the processing unit, wherein an operating program for the open-loop or closed-loop control of at least one data process is running on the processing unit.

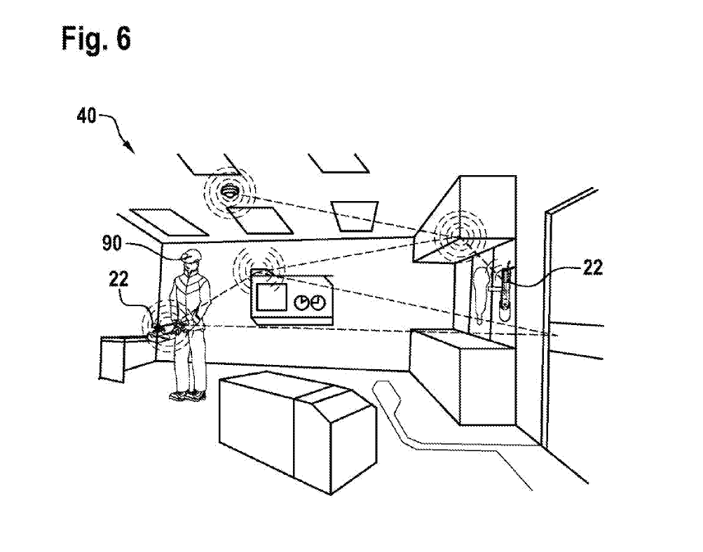

If the at least one data processing device 38 has identified the person 20 detected by means of the at least one detection element 18 and/or the equipment 22 carried by the person 20 during their passage through the device as having access authorization, then in an inventive manner the passage control device 10 allocates the person 20 a work sub-area 40 (cf. FIG. 6) and/or a specific activity within the access-restricted work area 12. On the other hand, the passage of the person 20 to the access-restricted work area 12 is identified as not having authorization if the person 12 does not possess a required instruction or training, and/or if the equipment 22 carried by the person 20 may not be introduced into the access-restricted work area 12. In this case, it is also provided that the person identified as not having authorization does not obtain access to the access-restricted work area 12.

For displaying information about the granted or not granted access authorization, the passage control device 10 has at least one output or display unit 42, which in FIG. 1 is implemented as a simple lamp 44, which lights green if the access authorization is granted and red if the access authorization is not granted. It can also be provided that in the event of a restricted access authorization, an orange light is illuminated.

In FIG. 2, in addition to or as an alternative to the lamp 44, a human-machine interface (HMI) in the form of a touch screen 46 is shown, possibly with another control unit 47. This is used to indicate to the person during their passage what permissions they have, i.e. which work sub-areas 40 within the access-restricted work area 12 they are allowed to enter and/or what activities they have to conduct in the work sub-area 40. In addition, directly via the HMI, a short briefing can be given to the person 20 on the local conditions and/or training on the necessary pre-conditions for access authorization. Furthermore, on the inner side 30 of the gate-like frame construction 14 the passage control device 10 has an output unit 42 in the form of a printer 48. This allows the person 20 to print out, for example, the above information and pre-conditions. The creation of a time-limited identification card for the access-restricted work area 12 is also conceivable. For example, the person 20 can also be informed that they are bringing a dangerous substance into the access-restricted work area 12, that certain rules apply to this and that the person must acknowledge their understanding or consent to these rules in order to obtain access authorization. In addition, it can be queried whether the person 20 has the necessary training and/or the necessary knowledge for handling such hazardous substances and other items of equipment 22.

For bidirectional data exchange of the data captured by means of the at least one detection element 18 and/or processed by the at least one data processing device 38, with an external data processing device 50, in particular with a central computer or a cloud, the passage control device 10 is equipped with at least one first communication interface 52. In this case, the at least one first communication interface 52 can use wireless transmission standards such as WLAN or the like, or wired services, such as Ethernet or Powerline. By transmitting the data to the external data processing device 50, it is possible to detect which person 20 is located in which access-restricted work area 12 or work sub-area 40 with which equipment 22 and which activity they are conducting there.

In a memory 51 of the external data processing device 50 and/or in a memory 53 of the data processing device 38 of the passage control device 10, the information can also be stored that the person 20 must perform a particular activity or has a specific job. It is conceivable to save a work plan with specific working hours and its fulfillment by the person 20. If violations or irregularities occur so frequently that a pre-defined threshold value is exceeded, these can be stored in the system and evaluated. In addition, it is possible to perform specific actions, such as sending a message to a supervisor, to security staff or the like, or to withdraw the access authorization from the person 20. In addition, information can be stored concerning the persons 20 entering the access-restricted work area and leaving the access-restricted work area 12 and/or concerning the equipment 22 carried by the persons 20, for inventory management and tracking purposes. This enables an efficient and fast anti-theft control of all items of equipment 22 in a very simple way. Furthermore, access to the access-restricted work area can be linked to a further accompanying person, because for example, their staying in hazardous areas or conducting their activity with certain items of equipment would be too dangerous if carried out alone.

The access authorization for the access-restricted work area 12 and/or for the work sub-area 40 can be actively adapted to a change in the need for the equipment 22 to be carried by the person 20 and/or the required training or knowledge of the person 20. Thus, it is possible, for example, to update the access authorization regularly and/or after the person 20 has successfully completed a test, or the like.

To supply the passage control device 10 with energy in the outdoor area, this has an energy recovery unit 54 in the form of solar cells or solar panels 56. For use inside buildings or under roofs or awnings, a power supply unit 58 is also provided as a power socket 60 for connection to a mains power supply of the access-restricted work area 12. Alternatively or in addition, other location-independent energy recovery and conversion units are also conceivable, such as a combustion engine acting as a generator. It is also advantageous if the energy thus generated is stored in an energy store of the passage control device 10, such as in a rechargeable battery or in a fuel cell.

To provide a mechanical connection of the passage control device 10 to access prevention elements 62 surrounding the access-restricted work area 12, for example in the form of fences 63, and/or to anchoring or fixing elements 64 belonging to the access-restricted work area 12, the passage control device 10 has at least one connection element 66. The nature of the connecting elements 66 should be familiar to a person skilled in the art, so that these will not be discussed in further detail here.

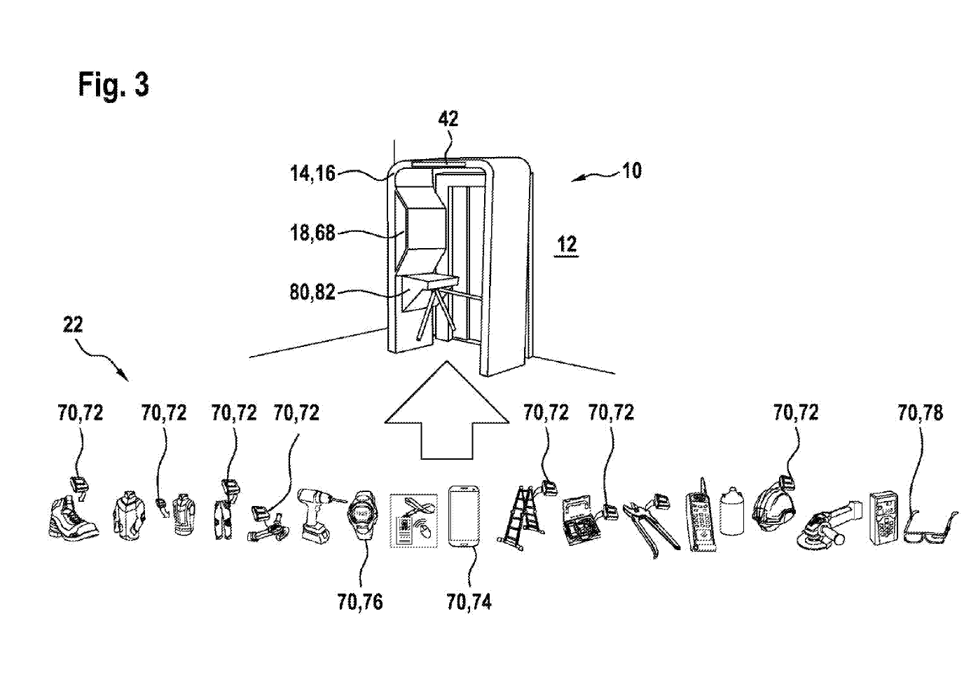

FIG. 3 shows another exemplary embodiment of a passage control device 10 according to the invention for an access-restricted work area 12, in the form of a mobile, gate-like frame construction 14, or a locking gate 16. The passage control device 10 comprises, in addition to or as an alternative to the passage control device 10 in accordance with FIGS. 1 and 2, a detection element 18, which is designed as an additional, wireless communication interface 68. The additional communication interface 68 is used for the unidirectional reception or bi-directional transmission of data from or to a communication interface 70 located on the person 20 and/or on the equipment 22 carried by the person 20, for example in the form of a transponder 72, smartphone 74, smart band 76, smart glasses 78, beacons or the like. In this case, without limiting the invention, the data transmission of the at least one other, wireless communication interface 68 can be based on data transmission standards such as WLAN, BT, BTLE, RFID, NFC, GSM, UMTS, Zigbee, Sub-1 GHz, Wireless M-Bus or similar standards. The individual equipment items 22 are assigned identification data, by means of which the passage control device 10 can determine which person 20 is involved and which equipment 22 they are carrying. To this end, it is conceivable that the communication interface 70 is integrated in the equipment 22 (for example, a transmitter module permanently integrated in an electrical tool) or is glued on, placed on or clipped on the equipment 22 in the form of modules or labels.

The passage control device 10 has at least one access enabling element 80 in the form of a turnstile 82, which enables the access of the person 20 to the access-restricted working area 12 in the event of an identified access authorization. In the event of a non-granted access authorization, or a non-authorization, the turnstile 82 remains locked in a known manner. The access authorization, whether granted or not granted, may be additionally indicated according to the exemplary embodiment according to FIG. 1 by the output and/or display unit 42. It can also be provided that the passage to the access-restricted work area 12 is enabled for the person 20 if the person has acknowledged the display and/or output of the output or display unit 42.

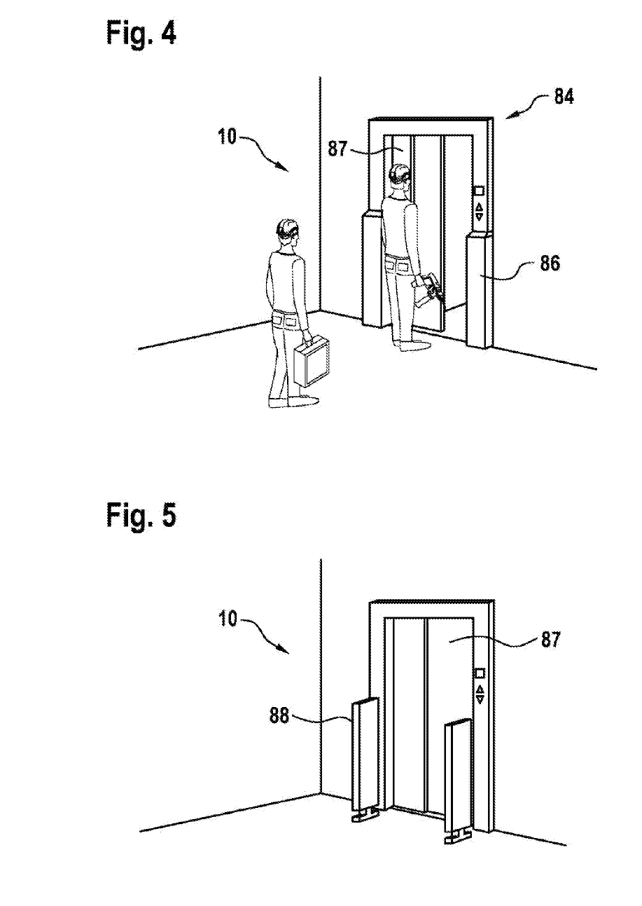

The FIGS. 4 and 5 show additional exemplary embodiments of a mobile passage control device 10 according to the invention, in the form of either one beacon 86 fixed to an elevator 84 and/or two beacons 88 positioned opposite one another. These can be provided with the same equipment as the passage control devices of FIGS. 1 to 3, so that these will not be further discussed here. Instead of an elevator door 87, other movable barrier elements in the form of sliding or rotating doors, barriers or the like, can also be used.

With reference to FIG. 6, in addition to the control function the passage control device 10 can also have additional functions within the access-restricted work area 12. For example, if a person 20 in the form of a service technician would like to enter the access-restricted work area 12, this is communicated to appropriately networked persons 90 and equipment 22 inside the access-restricted area 12, so that the equipment 22 to be serviced can be moved to the passage control device 10 or into a defined work sub-area 40. It is also conceivable that when the access-restricted area 12 is entered by certain persons 20 (e.g. an architect entering the construction site), safety-critical activities within the access-restricted work area 12 or a work sub-area 40 are suspended. Likewise, it can be defined that certain activities may only be conducted when only authorized persons 20 or 90 are present in the access-restricted work area 12.

The invention further comprises a system consisting of a plurality of passage control devices 10 for different access-restricted work areas 12. In this case, the passage control devices 10 can communicate with each other directly via the first communication interface 52 and/or via the external data processing device 50. A system networked in such a way offers the possibility of a very detailed tracking of all persons 20 and items of equipment 22 beyond the confines of an access-restricted work area 12. In addition, it is thereby possible to transmit events from one access-restricted work area 12 very simply and rapidly to another access-restricted work area 12.

Finally, it should be pointed out that the exemplary embodiments shown are limited neither to FIGS. 1 to 6 nor to the items of equipment disclosed there.

1. A passage control device for an access-restricted work area, comprising:
at least one detection element; and
at least one data processing device,
wherein the passage control device is configured as a mobile device and is further configured to check the passage of a person to the access-restricted work area in such a way that the passage control device assigns the person a work sub-area and/or a specific activity within the access-restricted work area if the at least one data processing device has identified the person by detecting the at least one detection element and/or the equipment carried by the person as having access authorization.

2. The passage control device as claimed in claim 1, further comprising:
at least one access enabling element configured to enable access of the person to the access-restricted work area in the event of an identified access authorization.

3. The passage control device as claimed in claim 2, wherein the at least one access enabling element is configured as a turnstile, a door, a barrier or a suitable movable barrier element.

4. The passage control device as claimed in claim 1, wherein the at least one detection element is configured as a light barrier a camera, a biometric sensor, a metal detector, barcode scanner, SMART card scanner, QR code scanner, body scanner, IR-Scanner, or UWB scanner.

5. The passage control device as claimed in claim 1, further comprising:
at least one first communication interface configured for bidirectional data exchange with an external data processing device.

6. The passage control device as claimed in claim 1, wherein the at least one detection element is configured as a wireless communication interface for the unidirectional reception or bi-directional transmission of data from or to a communication interface located on the person and/or on the equipment carried by the person.

7. The passage control device as claimed in claim 1, wherein the passage control device is configured as a substantially gate-like frame construction, as a lock gate or at least as a beacon.

8. The passage control device as claimed in claim 1, further comprising:
at least one power supply unit, an energy recovery unit, an energy conversion unit and/or an energy storage unit configured to supply the passage control device with energy.

9. The passage control device as claimed in claim 1, further comprising:
at least one connection element configured to mechanically connect the passage control device to access prevention elements surrounding the access-restricted work area and/or to anchoring or fixing elements belonging to the access-restricted work area.

10. The passage control device as claimed in claim 1, further comprising:
at least one output and/or display unit configured to output or display information about the type and/or the scope of the access authorization.

11. (canceled)

12. A method for carrying out a passage control having at least one passage control device comprising:
carrying out a verification during a passage of a person to an access-restricted work area in such a way that, in the event of access authorization being granted, a work sub-area and/or a specific activity within the access-restricted work area is assigned to the person.

13. The method as claimed in claim 12, further comprising:
identifying the passage of the person to the access-restricted work area as not having authorization if the person does not have a required instruction and/or training, or if a piece of equipment carried by the person may not be introduced into the access-restricted work area.

14. The method as claimed in claim 12, further comprising:
preventing a person identified as not having authorization from obtaining access to the access-restricted work area.

15. The method as claimed in claim 12, further comprising:
storing information about the persons who have entered the access-restricted work area and those leaving the access-restricted work area and/or about the equipment carried by the persons in a memory of a data processing device of the passage control device and/or an external data processing device for inventory management and tracking.

16. The method as claimed in claim 12, further comprising:
giving, in the event of a non-authorization, a display and/or output to the person on a reason and/or a extent of the non-authorization and/or on a condition for an access authorization.

17. The method as claimed in claim 12, further comprising:
giving, in the event that access authorization is granted, a display and/or output to the person concerning an extent of the access authorization, including the work sub-areas of the access-restricted work area to be entered and/or the specific activities to be performed within the access-restricted work area, and/or a handling of accompanying equipment, including hazards associated with the accompanying equipment and/or concerning a completeness of the accompanying equipment.

18. The method as claimed in claim 16, wherein the passage to the access-restricted work area is not enabled until the person has acknowledged the display and/or output.

19. The method as claimed in claim 12, further comprising:
upon a threshold value for a number of violations or irregularities being exceeded by the person (i) sending a message concerning the violations or irregularities to another person, including a superior of the person, and/or (ii) withdrawing the access authorization of the person for the access-restricted work area.

20. The method as claimed in claim 12, further comprising:
informing at least one further person located in the access-restricted work area about the access of the person to the access-restricted work area, about the activities to be carried out by the person and/or about the equipment required by the person.

21. The method as claimed in claim 12, further comprising:
actively adapting the access authorization for the access-restricted work area and/or for the work sub-area to a change in a need for the equipment to be carried by the person and/or required training or knowledge of the person.
